(19) United States
(12) Patent Application Publication
(10) Pub. No.: US 2013/0275280 A1
(43) Pub. Date: Oct. 17, 2013

(54) Systems and Methods for Managing Accounting Data

(71) Applicant: Veerachettiar Nagaraj, Parramatta (AU)

(72) Inventor: Veerachettiar Nagaraj, Parramatta (AU)

(73) Assignee: IMPACT MANAGEMENT GROUP PTY LTD, Parramatta (AU)

(21) Appl. No.: 13/878,135

(22) PCT Filed: Oct. 6, 2011
(86) PCT No.: PCT/AU2011/001273

§ 371 Date: May 30, 2013

Related U.S. Application Data
(60) Provisional application No. 61/390,271, filed on Oct. 6, 2010.

(30) Foreign Application Priority Data
Oct. 6, 2010 (AU) 2010226977
May 30, 2011 (AU) 2011902094

(51) Int. Cl. G06Q 40/00

(52) U.S. Cl. CPC G06Q 40/10
USPC 705/30

(57) ABSTRACT

Described herein are systems and methods for managing accounting data. In overview, the present Detailed Description is focused on a web-hosted accounting platform which embodies various significant aspects of the present technology. These include the likes of client/accountant interaction, report generation and submission (for example using SBR or another predefined protocol), and ID key management. It will be appreciated that these aspects of technology in other embodiments exist independently of one another, optionally within other software platforms which may be web-hosted or locally executed.

### FIELD OF THE INVENTION

The present invention relates to systems and methods for managing accounting data. Embodiments of the invention have been particularly developed for interfacing users with government authorities, such as taxation offices, for example allow streamlined submission of taxation documentation or the like. Whilst some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Various accounting software package are known, with common examples being MYOB and Quickbooks. In broad terms, these allow as user to maintain accounting records, and generate reports in respect of those records. These records may be used to assist in the completion of taxation documentation or the like. However, the process by which a user submits reports to a government authority remains complex, often requiring the use of a separate unfamiliar application to enable online submission of the report data.

There is a need in the art for improved systems and methods for managing accounting data.

### SUMMARY OF THE INVENTION

It is an object of the present invention to overcome or ameliorate at least one of the disadvantages of the prior art, or to provide a useful alternative.

One embodiment provides a system for managing accounting data, the system including:

a user portal, accessible to a plurality of users via the Internet, the user portal being configured to allow each user to maintain a respective set of accounting data, the accounting data being hosted at a central location;

an accountant portal, accessible to a plurality of accountant users via the Internet, the accountant portal being configured to allow a given accountant user to access the accounting records one or more users respectively represented by that accountant user;

a report submission module that is configured to submit data indicative of reports generated based on the accounting data of respective users to one or more receiving authorities, wherein the data is submitted in compliance with data submission protocol requirements associated with the receiving authority to which the submission is made; and

a key management module for storing a plurality of government issued ID keys, wherein each key is associated with a given one of the users, and wherein the report submission module is configured to, when submitting data indicative of a generated report, associate the data indicative of the report with data indicative of the ID key for the user based on who's accounting data the report is based.

One embodiment provides a system including a report submission knowledge module, which is configured to maintain data indicative of a plurality of submittable reports, and data submission protocol requirements associated with the receiving authority to which the report is to be submitted for each of those reports.

One embodiment provides a system including a report generation module that is responsive to a user command for generating a user-selected report in compliance with the report submission knowledge module.

One embodiment provides a system including a key submission module for allowing each user to upload a respective government issued ID key to the key management module, such that the uploaded ID keys are centrally stored on behalf of the users.

One embodiment provides a system including an accounting module configured to allow the users to view, modify and generate reports in respect of their respective sets of accounting data via a web-browser arrangement.

One embodiment provides a system wherein the accounting module is configured to be periodically updated thereby to implement a change in accounting functionality across the plurality of users and accountant users.

One embodiment provides a system wherein a user is enabled to generate a report for submission via the report submission module and, prior to submission of that report, provide a request for an accountant user to review the report and accounting data upon which the report is based.

One embodiment provides a system including a report submission management module that is configured to maintain a queue of sets of data indicative of respective individual reports for submission, and manage the submission of those reports to a government authority server.

One embodiment provides a system including a client-facing report receiving module configured for receiving data for submission in a report by the report submission module, wherein the data for submission in a report is received from a one of a plurality of third party proprietary software applications via an API.

One embodiment provides a system including a client-facing report receiving module configured for receiving data for submission in a report by the report submission module, wherein the data for submission in a report is received from a web-based interface that allows users to submit information via web-fillable forms.

One embodiment provides a computer implemented method for managing accounting data, the method including:

providing an interface for allowing a plurality of users to interact with a web-hosted accounting platform;

defining, via the web-hosted accounting platform, a user account for a first user, wherein that user account is configured to be associated with accounting records defined by the first user via the web-hosted accounting platform; and

providing, via the web-hosted accounting platform, access to a second user in respect of the accounting records defined by the first user, wherein the second user is identifiable as an accountant representative of the first user.

One embodiment provides a method wherein providing access to the second user includes providing the second user with the ability to view and/or modify the accounting records defined by the first user.

One embodiment provides a method wherein the web-hosted accounting platform includes a facility for enabling communication between the first user and the second user.

One embodiment provides a method wherein the facility for enabling communication between the first user and the second user allows one of those users to identify a particular aspect of the accounting records and provide a message to the other of the users, wherein the message is inherently indicative of the identified aspect.

One embodiment provides a method wherein the web-hosted accounting platform is configured to:

generate reporting data in response to a user request;

submit the reporting data to a receiving authority in response to a user request, wherein the reporting data is transmitted in accordance with a predefined protocol stipulated by the receiving authority, and wherein the reporting data is associated with data indicative of a government issued ID key associated with the first user, wherein the government issued ID key is maintained at a central location accessible to the web-hosted accounting platform.

One embodiment provides a method for managing accounting data, the method including:

providing an accounting module for allowing a user to maintain a set of accounting records;

providing a report submission knowledge module, which is configured to maintain data indicative of a plurality of submittable reports, and data submission protocol requirements for each of those reports;

providing a report generation module that is responsive to a user command for generating a user-selected report in compliance with the report submission knowledge module;

providing a report submission module that is configured to submit data indicative of the generated report to a receiving authority associated with the user, wherein the data is submitted in compliance with data submission requirements maintained by the report submission knowledge module.

One embodiment provides a method wherein the report submission module associates each report with a receiving authority, and each receiving authority with a predefined data submission protocol.

One embodiment provides a method wherein, for one or more the receiving authorities, the predefined data submission protocol is an SBR protocol.

One embodiment provides a method wherein the method includes providing a key submission module for allowing each user to identify a government issued ID key, wherein the report submission module is configured to, when submitting data indicative of a generated report, associate the data with data indicative of the ID key.

One embodiment provides a method wherein the method is performed at a central server accessible to a plurality of users that each maintain respective sets of accounting data, and the method additionally includes:

providing a key upload module for allowing each user to upload a respective government issued ID key; and

providing an ID key repository for maintaining the uploaded keys;

wherein the report submission module is configured to, when submitting data indicative of a generated report, associate the data with data indicative of the ID key uploaded by the user responsible for the generated report.

One embodiment provides a method for managing accounting data, the method including:

receiving, from a user, data indicative of a selected report type;

identifying a receiving authority associated with the user;

providing to the receiving authority a request for information relevant to the selected report type associated with the user;

receiving the requested information from the receiving authority;

presenting to the user a representation of the received information;

allowing the user to review/modify the representation of the received information; and

upon approval of the representation, providing to the receiving authority data indicative of the approved representation, thereby to submit a report of the selected report type.

One embodiment provides a method wherein the information received from the receiving authority is indicative of a pre-filled report of the selected report type.

One embodiment provides a method including comparing the information received from the receiving authority with accounting data defined by the user.

One embodiment provides a method wherein providing to the receiving authority a request for information relevant to the selected report type associated with the user includes providing to the receiving authority data indicative of a government issued ID key associated with the user.

One embodiment provides a method wherein the method is performed at a central server accessible to a plurality of users.

One embodiment provides a computer implemented method for submitting reports to a government authority, the method including the steps of:

providing a key upload module for allowing a plurality of registered users to upload respective government issued ID keys;

providing an ID key repository for maintaining the uploaded keys;

providing a client-facing report receiving module for receiving, from a registered user, data for submission in a report;

processing the data for submission in a report thereby to define a report submission data set compliant with a government authority submission protocol;

providing the report submission data set so a report submission management module that is configured to maintain a queue of one or more report submission data sets and manage the submission of those reports to a government authority server in accordance with the government authority submission protocol;

wherein the report submission module is configured to, when submitting a given report submission data set, associate the submission with data indicative of the ID key uploaded by the registered user responsible for that report submission data set.

One embodiment provides a computer system including a web server configured to deliver a web based interface to a plurality of user terminals, wherein the web server is configured to perform a method as described herein

One embodiment provides a computer system including a web server configured to deliver a web based interface to a plurality of user terminals, wherein the web server is configured to perform a method as described herein.

One embodiment provides a computer system including a microprocessor configured to perform a method as described herein.

One embodiment provides a tangible non-transient computer readable medium carrying executable code that when executed on one or more microprocessors of a computer system cause the computer system to perform a method as described herein.

One embodiment provides a computer program product configured for allowing the performance of a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 schematically illustrates a framework according to one embodiment.

FIG. 2 provides an overview of user interactions according to one embodiment.

FIG. 3 provides a system level overview according to one embodiment.

FIG. 4A illustrates a method according to one embodiment.

FIG. 4B illustrates a method according to one embodiment.

FIG. 5A schematically illustrates a framework according to one embodiment.

FIG. 5B schematically illustrates a framework according to one embodiment.

### DETAILED DESCRIPTION

Described herein are systems and methods for managing accounting data. In overview, the present disclosure is focused in part on a web-hosted accounting platform which embodies various significant aspects of the present technology. These include the likes of client/accountant interaction, report generation and submission (for example using SBR or another predefined protocol), and ID key management. It will be appreciated that these aspects of technology in other embodiments exist independently of one another, optionally within other platforms which may be web-hosted or locally executed. The present disclosure also describes a framework including a centralized report submission server thereby to manage report submissions across a plurality of government lodgment servers.

### General Framework

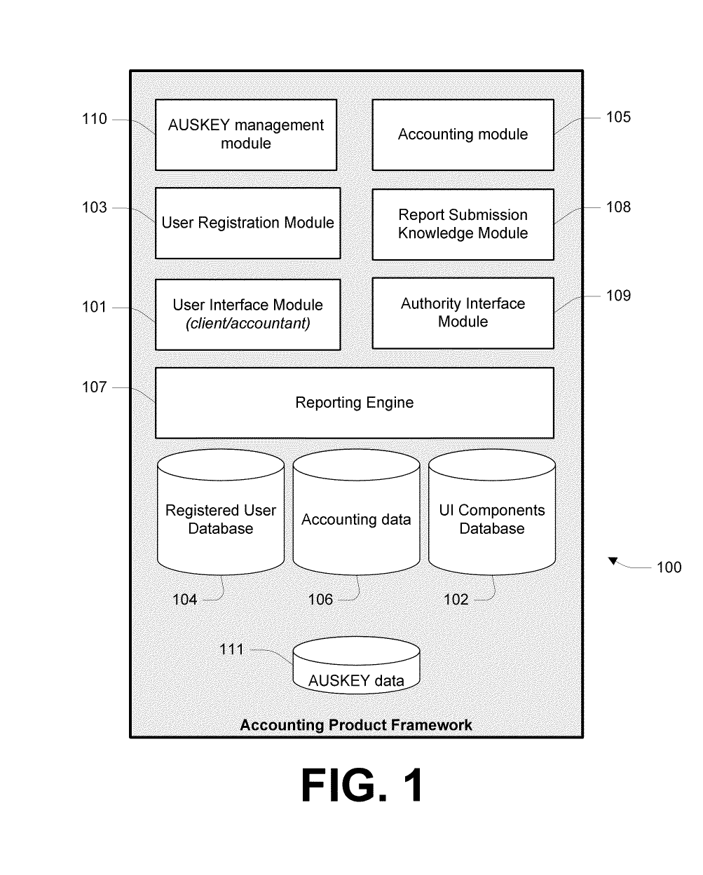

FIG. 1 provides a schematic overview of an accounting framework 100 which provides a web-based accounting platform. This framework is conceptually split into a number of logical components, which need not be physically separated. For example, these components may be collectively provided by one or more software applications executing on one or more computing platforms (optionally distributed platforms). It should be appreciated that not all of these logical components are present in all embodiments.

The term “user”, as used herein, is not intended to represent a human user. Rather, the term “user” describes a unique set of user registration data which, at a practical level, may me intended to represent a single human user, corporation, or the like. It is appreciated that multiple people could access framework 100 using the same user registration data. However, such multiple people should not be confused with multiple “users”. Rather, this presents an example of multiple people accessing framework 100 under the guise of a common user. This may occur where multiple people interact with framework 100 on behalf of a corporation, or where one person fraudulently utilizes user registration data belonging to another person.

Framework 100 includes user interface module 101, which in conjunction with a User Interface (UI) components database 102, provides data and logic for driving a user interface. In the present embodiments, this user interface is web-delivered for rendering within a client web-browser application. That is, module 101 in conjunction with database 102 provides to a remote client terminal code which, when rendered in a browser application at the remote terminal, causes a user interface (or one or more components thereof) to be rendered. From a functional standpoint, the user interface module provides functionalities including displaying information from framework 100 to a user, and for receiving input from a user (for example via a postback operation), wherein that input is intended for provision to framework 100.

In the present embodiment, module 101, in conjunction with database 102, provides a user interface for allowing user interaction with a web-based accounting platform, wherein back-end processing for the accounting platform is performed at a server remote of the users' terminals. As used herein, the term “web-based accounting platform” describes an arrangement including a software application that is hosted via one or more web servers, thereby to provide a plurality of users with functionality to maintain respective sets of accounting data. In this sense, the term “maintain” refers to a process by which a user, for example, inputs data indicative of real-world events (such as payments and receipts) into an accounting platform, such that the accounting platform is able to report on aspects of that user's accounts (such as cash flow, profit and loss, budgeting, and in some cases, as discussed below, information for government reports).

The specific methodologies by which accounting data is maintained by each user (for example specific mechanisms for input of income and expenditure data, bank reconciliations, and so on) are generally ignored for the present purposes, as a wide range of accounting platforms (such as the many known platforms that execute locally at client machines) are well known in the art. Various embodiments make use of varying levels of complexity and sophistication in terms of functionalities by which accounting data is maintained.

A user registration module 103 operates in conjunction with a registered user database 104 for providing a process whereby a user registers to use framework 100. For example, a user provides various aspects of personal information (or more specifically a human user provides aspects of personal information concerning the entity to be represented by the user), and is associated in database 104 with a username and password thereby to allow identification of the user. User registration module 103 is responsible for defining a user account for each user upon registration, and each user account is configured to be associated with accounting records defined by the relevant user. More specifically, an accounting module 105 operates in conjunction with a repository of accounting data 106 thereby to allow each user to maintain their own accounting records, with the substantive software and accounting data being hosted remotely of the user (due to the web-hosted nature of the framework). That is, a user's accounting data is maintained centrally by framework 100, as opposed to on the hard drive of a local computing device operated by the user.

Framework 100 provides a reporting module 107, which assists a user in generating reports for direct submission to a receiving authority. For example, the receiving authority may be the Australian Taxation Office (for Australia) or the IRS (for the US). In some cases framework 100 operates internationally and allows submission to multiple receiving authorities, either on a user level (i.e. based on the jurisdiction in which a user is registered) or a report level (i.e. based on the authority associated with a particular report). For instance, in some embodiments each user is associated with a receiving authority for all taxation-type reports. In cases where module 107 is configured for generating reports for receipt by a plurality of receiving authorities in respect of a given user, such as federal and state taxation offices, the user is associated with the plurality of receiving authorities.

Module 107 interacts with a report submission knowledge module 108, which is configured to maintain data indicative of a plurality of submittable reports, and data submission protocol requirements for each of those reports. For example, these reports may include taxation related reports, such as a Business Activity Statement (BAS) as required under Australian taxation regulations. As context, various government agencies are known to develop predefined data submission protocols, which are in some cases to an extent standardized across jurisdictions. One example is provide by SBR (standard business reporting) protocols, which have been implemented by various Australian government agencies, and government agencies outside of Australia. Another example is IFS reporting standards. Module 108 maintains data related to reports submittable via these protocols. In some embodiments module 108 the associates each report with a receiving authority, and each receiving authority with a predefined data submission protocol.

Module 108 is updated periodically, thereby to maintain a repository of up-to-date report knowledge. In this manner, as reporting standards evolve, framework 100 is able to implement changes in the standards across the plurality of users in a straightforward transparent and seamless manner.

Module 108 is significant in the sense that it provides a layer of differentiation between a user's accounting practices and government stipulated protocols. From one perspective, it can be viewed as a translation mechanism between the two, in the sense that it identifies data types required for a government stipulated protocol, and identifies the location of those data types in database 106.

From a practical perspective, a user selects a type of report that is to be prepared, and module 107 operates in conjunction with module 109 (and other modules of framework 100, as appropriate) thereby to prepare the report. The report is subsequently able to be submitted to the receiving authority. For this purpose, framework 100 includes a report submission module (shown as authority interface module 109) that is configured to submit data indicative of a generated report to the relevant receiving. The data indicative of the repost is submitted in compliance with data submission requirements maintained by the report submission knowledge module (for example via a SBR protocol compliant communication).

The use of a web-hosted framework has a range of advantages as compared with locally hosted software, for example in terms of the ability to modify/update the software centrally, thereby to deliver updated/modified functionality to users without a need to modify software at the users' local terminals. This is particularly useful in terms of managing complications associated with evolving accounting standards, taxation and other requirements, and data submission standards. That is, centrally updating module 105 has an instantaneous and simultaneous effect on all users. Likewise, the framework enables global data transformations and/or migrations of the multiple users' data in repository 106 to coincide with updates to module 105. In terms of technical effect, this is quite significant. For example, assume a change in taxation requirements is enacted by a government. This may have ramifications in terms of accounting practices, reporting requirements, and report submission requirements. A central model such as that of framework 100 facilitates a seamless and in many cases transparent crossover to the new requirements across all users. For example, an central software updates are performed at the crossover time stipulated by the enactment of new requirements such that all user interactions (in terms of maintaining, reporting and submission) are compliant on both sides of the crossover time. In some cases the update provides for staggered crossover, for example with an update effecting account maintaining practices preceding an update affecting report submission protocols.

Framework 100 provides a key submission module for allowing each user to identify a government issued ID key (being an encrypted key, as opposed to an alphanumeric identifier or the like). In the context of FIG. 1, this is shown as an AUSKEY management module 110, an AUSKEY being a government issued ID key used in Australia. Other embodiments make use of alternate key submission modules, configured for various jurisdictions, and the present example of an AUSKEY is for the sake of explanation only (with alternate keys being used in other embodiments). A user is able to upload an AUSKEY, which is stored in database 111. Module 109 is configured to interact with database 111 thereby to associate communications to a receiving authority with the relevant users government issued ID key., for example when submitting data indicative of a generated report, associate the data with data indicative of the ID key.

In overview, various government issued ID keys, with AUSKEY as a particular example, are designed to authorize a particular terminal to interact with government agencies on behalf of a business to whom the key is assigned. Under the current AUSKEY arrangement, data indicative of the ID can be maintained on a USB-type device, thereby to authorize whichever terminal the USB-type device is inserted (for the duration of the insertion). The data can also be installed on a terminal, thereby to authorize that terminal (for the duration of the installation, or until the expiry of the key). The present embodiments leverage benefits associated with web-delivered software thereby to allow users to maintain AUSKEY data at a hosted location, thereby to overcome complications associated with the use of multiple terminals. In essence, framework 100 is capable of being AUSKEY authorized for each of the registered users. In this manner, it does not matter which terminal a user interacts with for the purpose of accessing framework 100; the user is able to maintain their accounting data and generate/submit reports.

Module 109 is configured to manage the submission of reports via a queuing protocol, thereby to manage high volumes of data traffic resulting from a large number of users. A user simply request that a report be submitted, and module 109 places that report in a queue. In some cases the queue is prioritized based on importance ratings for individual reports (for example based on statutory deadlines).

Examples of the manner by which reports are generated and submitted are provided further below.

In some embodiments modules 107, 108 and 109 are separable from framework 100, and able to plug-in to third party software applications, thereby to provide the relevant functionalities to those programs.

### Party-Party Interactions

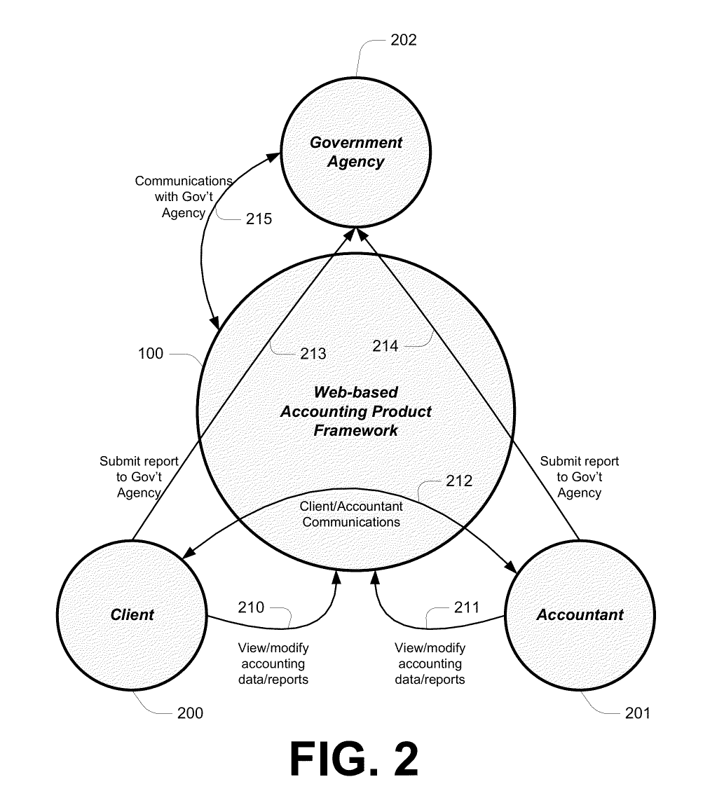

In some embodiments, framework 100 is configured to interface clients, accountants, and a government agency (or multiple government agencies, for example where users are spread across multiple jurisdictions). This is schematically illustrated in FIG. 2. In overview, framework 100 provides an interface for allowing a plurality of users to interact with a web-hosted accounting platform. These users include a first user, in the form of client 200. Client 200 is, for example, a small business that makes use of framework 100 for maintaining accounting data for the business.

Framework 100 defines a user account for client 200, that user account being configured to be associated with accounting records defined by client 200 via framework 100. Framework 100 additionally provides access to a second user in respect of the accounting records defined by client 100. Specifically, this second user is identifiable as an accountant representative 201 of client 200 (also referred to as an “accountant user”). To this end, framework 100 provides a user portal, for allowing users to access their respective accounting records, and a separate accountant portal, for allowing accountants to access the accounting records of users whom they respectively represent.

The manner in which accountant 201 is associated with client 200 varies between embodiments. In some cases, client 200 provides login and/or password information to their accountant, thereby to allow the accountant to create/obtain necessary permissions with framework 100. In other cases the accountant introduces client 200 to framework 100, and is inherently associated with client 200 when client 200 registers to use framework 100. For example, under one implementation model framework 100 is distributed via accounting service provider firms, and branded such that each client sees branding on the web-interface specific to their own accountant firm (that is, clients of one accountant firm are presented with different branding to clients of another accounting firm, although underlying functionalities remain unchanged). In another example, a user selects an accountant prior to report submission for a final pre-submission review, optionally on a one-off basis.

Regardless of the manner by which accountant 201 is associated with client 100, both are able to access the client's accounting data (see lines 210 and 211). In some cases this is able to occur simultaneously. Furthermore, in some embodiments the user interface presented to the accountant differs from that presented to the client. In some embodiments the accountant is restricted to viewing the accounting records defined by the client, whereas in other embodiments the accountant is able to modify those records. In cases where an account is provided with the ability to modify a user's records, there is preferably a mechanism for identifying modifications to the user, for example via a change mark-up/highlight process or the like.

In some cases framework 100 includes a facility for enabling communication between the client and accountant (see line 212), for example an in-application messaging facility. This allows the client and accountant to discuss various aspects of the client's accounting records, and/or reports generated in respect of those records. Although in-application messaging facilities are known, the application of such a facility to an accounting software framework presents distinct advantages in terms of streamlining client/accountant relationships. For example, the accountant is able to review a message, and look directly at the client's accounting records as maintained within the software framework (as opposed to reviewing a spreadsheet output or the like).

In some cases the messaging facility allows either the accountant or client to identify a particular aspect of the accounting records, and provide a message to the other party (e.g. from client to account or vice versa), wherein the message is inherently indicative of the identified aspect. For example, the client can select a particular report or entry, and select an option to contact the accountant. The accountant receives a message, which hyperlinks to a page displaying the relevant report or entry.

FIG. 2 additionally illustrates a government agency 202, such as a taxation office or the like. As discussed above, framework 100 is configured to allow direct submission of data to a receiving authority, such as government agency 202. As shown in FIG. 2, either client 200 or accountant 201 are able to submit reports to the government agency on behalf of the client (see lines 213 and 214). For example, a client may generate a report, send a message to their accountant requesting that the report be checked, and then the accountant can submit the report on behalf of the client.

As shown by line 215, framework 100 is configured to engage in communications with government agency 202. There are various purposes of such communications, with some being described further below.

In some embodiments interaction between the client and accountant is optional.

For example, in one embodiment framework 100 provides a form of advertising for accountants and other such service providers, whereby they can offer to review accounting records and/or reports for submission for clients using framework 100.

### Exemplary System-Level Overview

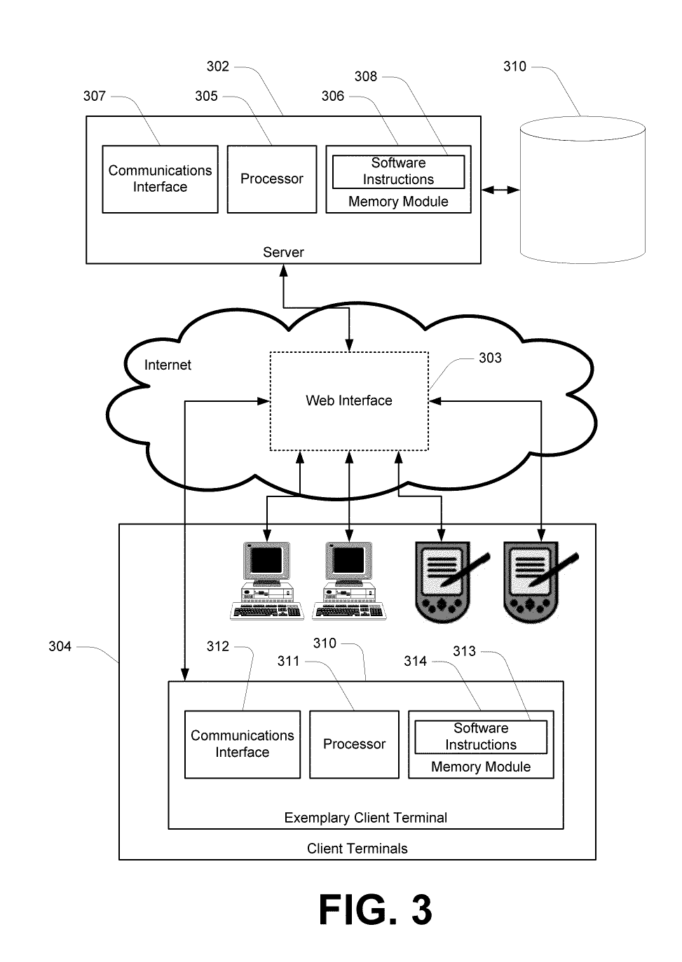

As noted, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310, which in this case provides the functionality of the conceptual database modules discussed in the context of FIG. 1.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Exemplary Report Generation and Submission Methods

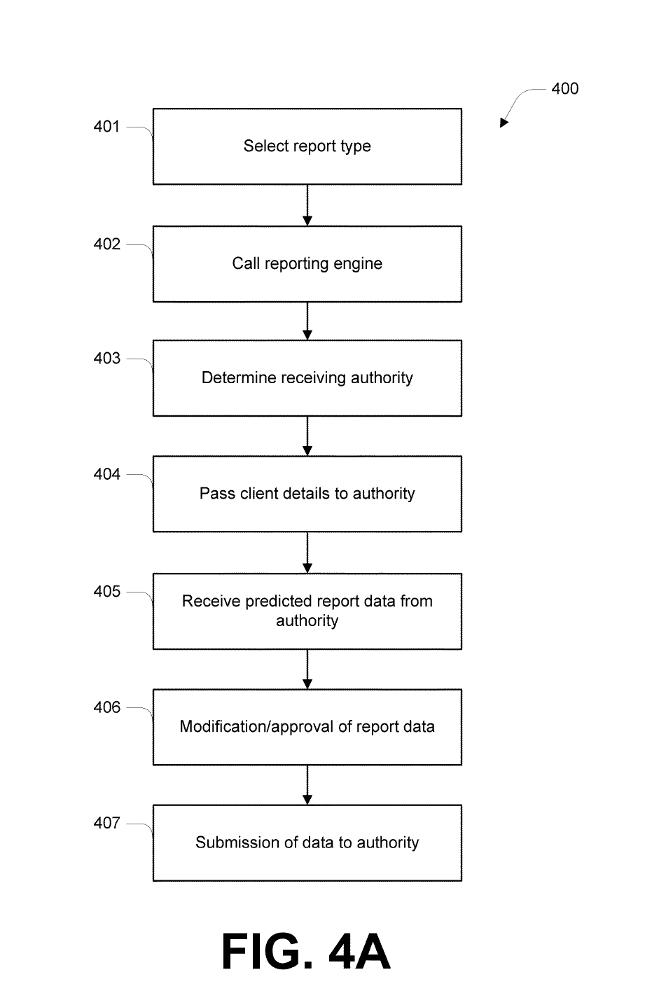

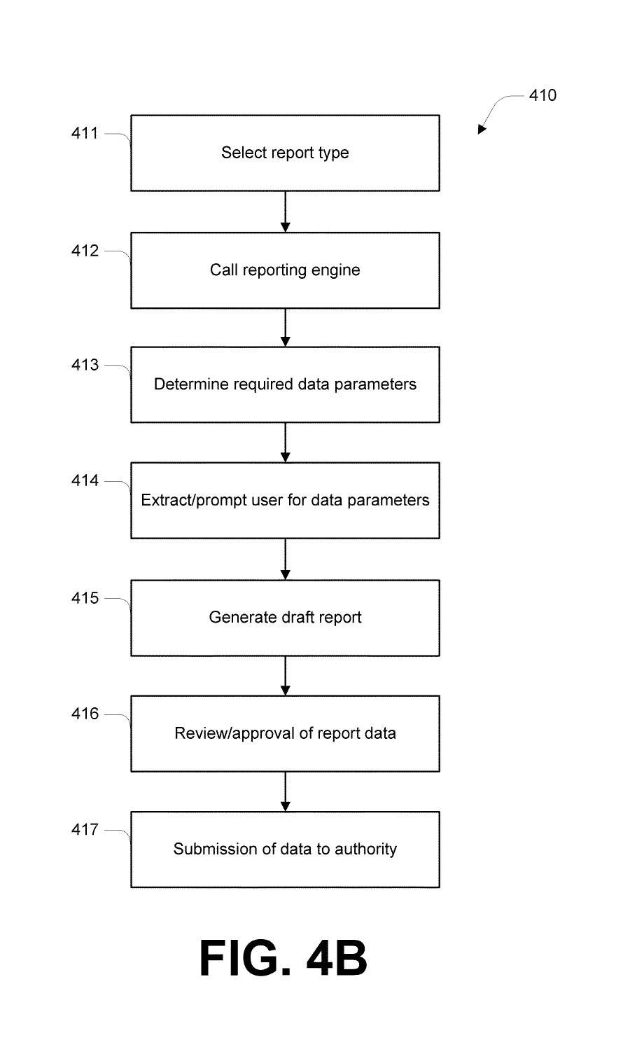

FIG. 4A and FIG. 4B illustrate exemplary computer implemented methods for generating and submitting reports via framework 100. It will be appreciated that these are exemplary only, and that framework 100 may be configured to perform either or both of these, and/or alternate methods using similar principles. Furthermore, these exemplary methods may be implemented via computer executable code residing other than in framework 100 (for example via locally hosted applications).

FIG. 4A illustrates a method 400 according to one embodiment. Functional block 401 represents a process whereby a user selects a report type. For instance, the user selects a report from a list of available reports. In some embodiments a user is prompted to select a particular report, for example where framework 100 recognizes that a statutory deadline for submitting a particular report is approaching. Examples of reports include tax statements, such as a quarterly business activity statement (BAS) as required in Australia.

Functional block 402 represents a process including calling the reporting engine based on the user's selection of a report type. The reporting engine determines the receiving authority at 403 based on either or both of the type of report and the user. The receiving authority may be determined based on the type of report (where different reports are provided to different authorities) and based on the user (for instance based on the jurisdiction in which the user operates, particularly relevant where framework 100 is implemented across a number of jurisdictions).

Functional block 404 represents a process including providing to the receiving authority a request for information relevant to the selected report type associated with the user. For example, this may include requesting a pre-filled report of the selected report type, or data that could be used to pre-fill a report. This is particularly relevant in circumstances where the receiving authority makes predictions as to what a report should contain, based on information submitted during part reporting periods. The user is identified to the receiving authority using the government issued ID key held by framework 100 (being an AUSKEY in the present embodiments). The requested information is received from the receiving authority at 405.

Functional block 406 represents a process including presenting to the user a representation of the received information in a modifiable format. For example, this representation may include a web page including values supplied by the receiving authority, optionally in combination with adjustable values (which may be modified by the client or accountant) and/or values predicted based on data extracted from the client's accounting records (as stored by framework 100). This allows a user (the client or accountant) to review/modify the representation of the received information.

Upon approval of the representation (i.e. a set of values within the representation), functional block 207 includes providing to the receiving authority data indicative of the approved representation, thereby to submit a report of the selected report type. The submission is performed using information provided by module 108, as discussed further above, thereby to ensure compliance with protocols for report submission stipulated by the receiving authority.

In summary, it will be appreciated that method 400 allows framework 100 to provide a user with predicted report values as defined for the receiving authority, and enable modification of these prior to report submission. Furthermore, it should be recognized that report submission occurs from within framework 100, as opposed to there being a need to export a report and use a separate software product to submit that report to the receiving authority.

Method 410 of FIG. 4B is in some cases provided as an alternative choice to a user of framework 100, and in other cases provided instead of method 400. Method 401 includes, at 411, the selection of a report type (similar to step 401), and the calling of the reporting engine at 412 (similar to step 402). Functional block 413 represents a process including determining required data parameters for the report in question. For example, these data parameters define the necessary information required to make a submission of the desired report type to the appropriate receiving authority in compliance with a protocol (such as SBR) stipulated by that authority. In the present embodiment, module 108 makes this information available.

Functional block 414 represents a process including extracting the required data parameters from the user's accounting data maintained by framework 103 or, where the necessary information in not available in this manner, prompting the user to input the necessary information. This is used to generate a draft report at 415, which is reviewed, optionally modified, and approved at 416. This may include review/modification/approval by either or both of the client and accountant. Following final approval, the report is submitted to the receiving authority at 417 (which is similar to 407).

### Examples Using Report Submission Server

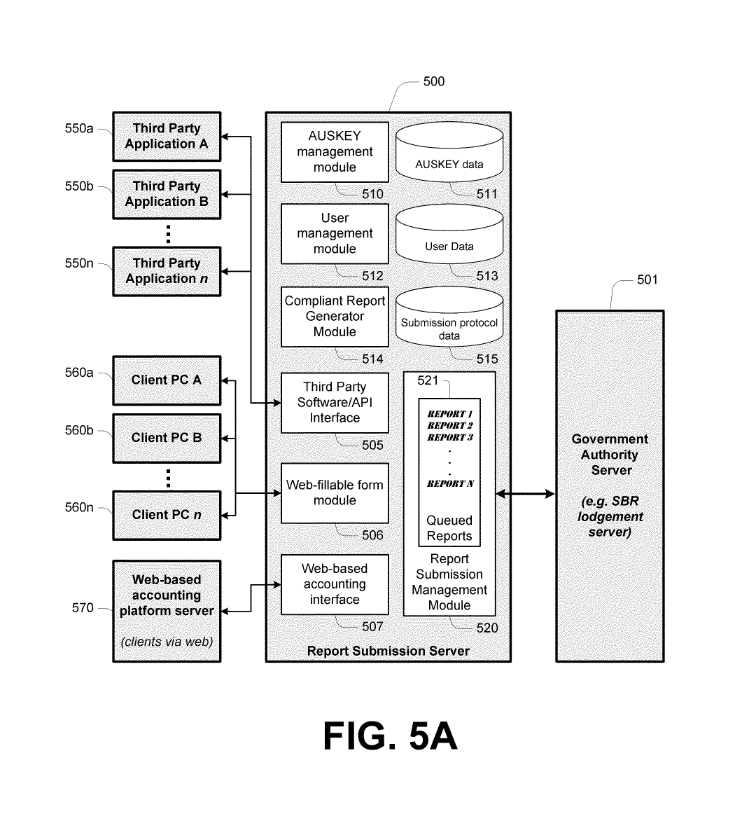

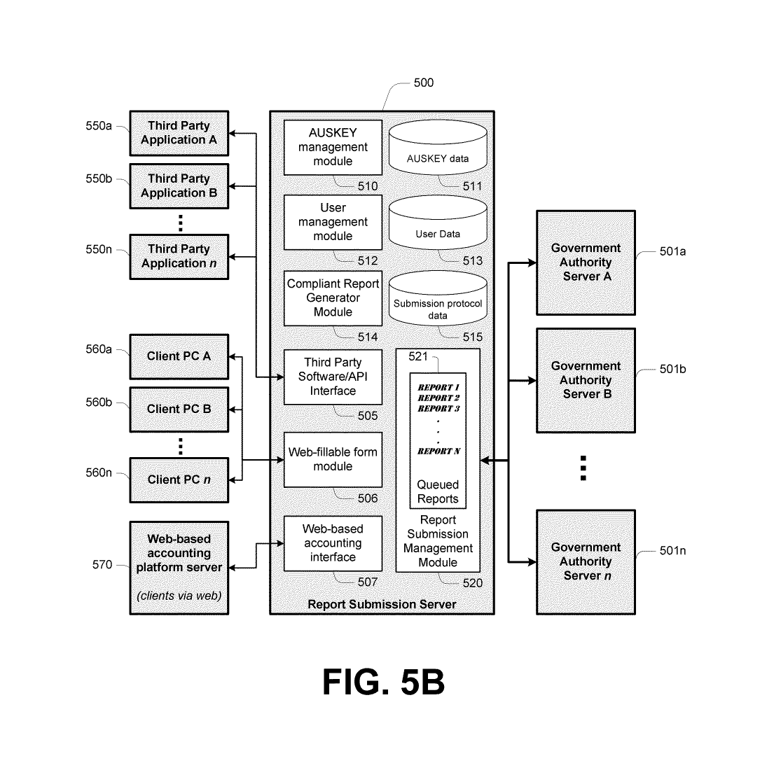

FIG. 5A and FIG. 5B illustrate embodiments including a report submission server 500. It will be appreciated that functionalities and/or components discussed in the context of FIG. 5A and FIG. 5B may be implemented in conjunction with any of the other embodiments discussed herein. For example, various embodiments implement hybridizations of framework 100 and server 500. In one embodiment all functionalities of server 500 are integrated into server 100.

In overview, server 500 is configured to perform a method for interfacing registered users with a government authority server 501 (or, in the case of FIG. 5B, a plurality of government authority servers 501a-501n). Server 501 is configured to receive reports via a predetermined government authority submission protocol, such as a SBR protocol. In overview, one purpose of server 500 is to separate users from shortcomings and challenges resulting from the nature of server 501 and the government authority submission protocol implemented by that server. These shortcomings/challenges may result at a technical level (for example in terms of an inability of sever 501 to receive a batch of multiple reports, or server downtime) or at a practical level (for example problems in the submission protocol). In this manner, server 500 takes steps to convert the submission services provided by server 501 into something more suitable in a commercial environment (i.e. it improves accessibility and effectiveness of electronic government report submission from an end-user perspective).

Server 500 includes a user management module 512, which operates in conjunction with a user data database 513 for managing user data. This includes user identification data, thereby to allow identification of a user in respect of which particular actions of server 500 apply. In some cases database 513 additionally maintains records of reports submitted by users, thereby to allow users to obtain copies of reports as required. Additionally, database 513 is in some cases configured to provide storage for other user data relevant to reporting, such as copies of receipts and/or other records. In some cases user management module interacts directly with users, whereas in other embodiments it interacts with users via intermediate servers (such as web-based accounting platform server which provides user data to server 500).

Server 500 includes a key upload module for allowing a plurality of registered users to upload respective government issued ID keys. In the example of FIG. 5A this is an AUSKEY management module 510, however it will be appreciated that the example of AUSKEY is by no means intended to be limiting. Other embodiments support alternate forms of government-issued ID keys (in some cases multiple forms). Module 510 operates in conjunction with a database 511 which maintains data indicative of the keys. In some embodiments the government-issued ID keys are defined in the first instance by data on a USB stick, which by design requires the user to have that USB stick inserted in a computer when interacting with server 501 in the conventional manner, or a key which authorizes a particular unique computer to interact with server 500. Server 500 maintains the necessary data thereby to allow submission of reports on behalf of the user via server 500. Furthermore, this enables a user to submit reports from substantially any computer without special authorization, as AUSKEY data is centrally stored and managed. This overcomes complications in cases where a particular human user wishes to use a common computer to submit reports on behalf of a plurality of AUSKEY holders.

Server 500 provides a client-facing report receiving module for receiving, from a registered user, data for submission in a report. In the illustrated examples, server 500 includes three such modules, thereby to receive reports from clients via a plurality of different entry mechanisms. These are
A third party software/API interface 514. This is configured for receiving data for submission in a report from a plurality of proprietary software applications 550a-550n via an API. That is, an API is defined thereby to allow third parties to create custom proprietary applications to interact with server 500. This may be useful for banks and large accounting firms, which already have their own in-house preferred software applications. The API allows such applications to be modified thereby to allow interaction with server 500.
A web-fillable form module 506. This provides a web-based interface configured to allow clients 560a-560n to fill in web-forms that receive data for submission to server 501. However, the form and substance of these electronic forms is controlled by managers of server 500, thereby allowing for improvements above and beyond what might be provided by those responsible for server 501. In some cases module 506 includes components hosted on a web-server separate from server 500.
A web-based accounting interface 507 for receiving data from a web-hosted accounting platform, such as a platform based on framework 100. That is, an online accounting platform is used to allow a user to submit a report for lodgment, and that report is provided to server 500 for subsequent submission to server 510.

Server 500 includes a compliant report generator module 514. Module 514 is configured for processing the data for submission in a report (received via interface 505, module 506 or interface 507) thereby to define a report submission data set compliant with a government authority submission protocol used by server 501 (or the relevant one of servers 501a-501n). To this end, module 514 operates in conjunction with submission protocol database 515 with maintains rules for converting/checking data to define a report data set compliant with the relevant protocol. Database 515 is modified over time to account for variations in protocols.

Data sets defined by module 514 are provided to a report submission management module 520. The report submission module is configured to, when submitting a given report submission data set to server 501 (or one of servers 501a-501n), associate the submission with data indicative of the ID key uploaded by the registered user responsible for that report submission data set.

Module 520 maintains a queue 521 of reports for submission to server 500 (or one of servers 501a-501n, optionally with respective queues for each server). This allows for reports to be submitted by users in batches (for example via a third party application) even though server 500 is not configured to accept batched submissions (i.e. module 520 submits reports in a manner acceptable to the relevant government server). Furthermore, this allows for reports to be held and/or re-submitted due to server problems/downtime without user intervention. In this manner, server 500 allows for a “submit and forget” approach, whereby an end user does not have to worry about ensuring that a report is successfully submitted to server 501; module 520 takes on that responsibility (and optionally provides a “successful submission” receipt to the end user when submission has occurred). Accordingly, end users can submit in their own time, without having to be concerned with possibly unreliable government servers.

### CONCLUSIONS

It will be appreciated that the disclosure above provides various novel and inventive systems and methods for managing accounting data. It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A system for managing accounting data, the system comprising:
a user portal, accessible to a plurality of users via the Internet, the user portal being configured to allow each user to maintain a respective set of accounting data, the accounting data being hosted at a central location;
an accountant portal, accessible to a plurality of accountant users via the Internet, the accountant portal being configured to allow a given accountant user to access the accounting records one or more users respectively represented by that accountant user;
a report submission module that is configured to submit data indicative of reports generated based on the accounting data of respective users to one or more receiving authorities, wherein the data is submitted in compliance with data submission protocol requirements associated with the receiving authority to which the submission is made; and
a key management module for storing a plurality of government issued ID keys, wherein each key is associated with a given one of the users, and wherein the report submission module is configured to, when submitting data indicative of a generated report, associate the data indicative of the report with data indicative of the ID key for the user based on who's accounting data the report is based.

2. A system according to claim 1, further comprising a report submission knowledge module, which is configured to maintain data indicative of a plurality of submittable reports, and data submission protocol requirements associated with the receiving authority to which the report is to be submitted for each of those reports.

3. A system according to claim 1, further comprising a report generation module that is responsive to a user command for generating a user-selected report in compliance with the report submission knowledge module.

4. A system according to claim 1, further comprising a key submission module for allowing each user to upload a respective government issued ID key to the key management module, such that the uploaded ID keys are centrally stored on behalf of the users.

5. A system according to claim 1, further comprising an accounting module configured to allow the users to view, modify and generate reports in respect of their respective sets of accounting data via a web-browser arrangement.

6. A system according to claim 5 wherein the accounting module is configured to be periodically updated thereby to implement a change in accounting functionality across the plurality of users and accountant users.

7. A system according to claim 1 wherein a user is enabled to generate a report for submission via the report submission module and, prior to submission of that report, provide a request for an accountant user to review the report and accounting data upon which the report is based.

8. A system according to claim 1, further comprising a report submission management module that is configured to maintain a queue of sets of data indicative of respective individual reports for submission, and manage the submission of those reports to a government authority server.

9. A system according to claim 1, further comprising a client-facing report receiving module configured for receiving data for submission in a report by the report submission module, wherein the data for submission in a report is received from a one of a plurality of third party proprietary software applications via an API.

10. A system according to claim 1, further comprising a client-facing report receiving module configured for receiving data for submission in a report by the report submission module, wherein the data for submission in a report is received from a web-based interface that allows users to submit information via web-fillable forms.

11. (canceled)

12. (canceled)

13. (canceled)

14. (canceled)

15. (canceled)

16. A computer implemented method for managing accounting data, the method, comprising:
providing an accounting module for allowing a user to maintain a set of accounting records;
providing a report submission knowledge module, which is configured to maintain data indicative of a plurality of submittable reports, and data submission protocol requirements for each of those reports;
providing a report generation module that is responsive to a user command for generating a user-selected report in compliance with the report submission knowledge module;
providing a report submission module that is configured to submit data indicative of the generated report to a receiving authority associated with the user, wherein the data is submitted in compliance with data submission requirements maintained by the report submission knowledge module.

17. A method according to claim 16 wherein the report submission module associates each report with a receiving authority, and each receiving authority with a predefined data submission protocol.

18. A method according to claim 17 wherein, for one or more the receiving authorities, the predefined data submission protocol is an SBR protocol.

19. A method according to claim 16 wherein the method includes providing a key submission module for allowing each user to identify a government issued ID key, wherein the report submission module is configured to, when submitting data indicative of a generated report, associate the data with data indicative of the ID key.

20. A method according to claim 16 wherein the method is performed at a central server accessible to a plurality of users that each maintain respective sets of accounting data, and the method additionally includes:
providing a key upload module for allowing each user to upload a respective government issued ID key; and
providing an ID key repository for maintaining the uploaded keys;
wherein the report submission module is configured to, when submitting data indicative of a generated report, associate the data with data indicative of the ID key uploaded by the user responsible for the generated report.

21. (canceled)

22. (canceled)

23. (canceled)

24. (canceled)

25. (canceled)

26. A computer implemented method for submitting reports to a government authority, the method including the steps of:
providing a key upload module for allowing a plurality of registered users to upload respective government issued ID keys;
providing an ID key repository for maintaining the uploaded keys;
providing a client-facing report receiving module for receiving, from a registered user, data for submission in a report;
processing the data for submission in a report thereby to define a report submission data set compliant with a government authority submission protocol;
providing the report submission data set so a report submission management module that is configured to maintain a queue of one or more report submission data sets and manage the submission of those reports to a government authority server in accordance with the government authority submission protocol;
wherein the report submission module is configured to, when submitting a given report submission data set, associate the submission with data indicative of the ID key uploaded by the registered user responsible for that report submission data set.

27. A method according to claim 26 wherein the client-facing report receiving module includes an interface for receiving data for submission in a report from a web-hosted accounting platform.

28. A method according to claim 26 wherein the client-facing report receiving module includes an interface for receiving data for submission in a report from a plurality of proprietary software applications via an API.

29. A method according to claim 26 wherein the client-facing report receiving module includes an interface for receiving data for submission in a report from a web-based interface that allows registered users to submit information via web-fillable forms.

30. A method according to claim 26 wherein the client-facing report receiving module includes:
an interface for receiving data for submission in a report from a web-hosted accounting platform;
an interface for receiving data for submission in a report from a plurality of proprietary software applications via an API; and
an interface for receiving data for submission in a report from a web-based interface that allows registered users to submit information via web-fillable forms.

31. (canceled)

32. (canceled)

33. (canceled)

34. (canceled)

35. (canceled)
